(19) United States
(12) Patent Application Publication
(10) Pub. No.: US 2025/0198962 A1
(43) Pub. Date: Jun. 19, 2025

(54) PROCESS OF MANUFACTURING AN ELECTROCHEMICAL GAS SENSOR AND ELECTROCHEMICAL GAS SENSOR

(71) Applicant: Dräger Safety AG & Co. KGaA, Lübeck (DE)

(72) Inventors: Michael SICK, Lübeck (DE); Rolf ECKHARDT, Lübeck (DE); Steffen RITTEMANN, Lübeck (DE); Manuel GLIECH, Lübeck (DE)

(21) Appl. No.: 18/982,438

(22) Filed: Dec. 16, 2024

(30) Foreign Application Priority Data
Dec. 18, 2023 (DE) 10 2023 135 483.3

(51) Int. Cl. G01N 27/404; G01N 27/407; G01N 27/413

(52) U.S. Cl. CPC G01N 27/404; G01N 27/4078; G01N 27/413

(57) ABSTRACT

A process of manufacturing an electrochemical gas sensor is provided and an electrochemical gas sensor is obtainable by this process. The process includes the steps of: providing a substrate, the substrate having a through opening configuration including one or more through openings formed in the normal direction of the substrate, applying electrode material to an upper surface of the substrate and/or to a lower surface of the substrate, bonding the electrode material and the substrate so that the through opening configuration is closed by the electrode material to obtain a contact surfaces configuration including one or more contacts electrically contactable on the lower surface of the substrate opposite to the upper surface.

### CROSS REFERENCE TO RELATED APPLICATIONS

This application claims the benefit of priority under 35 U.S.C. § 119 of German Application 10 2023 135 483.3, filed Dec. 18, 2023, the entire contents of which are incorporated herein by reference.

### TECHNICAL FIELD

The present invention relates to a process of manufacturing an electrochemical gas sensor and to an electrochemical gas sensor obtained by this process.

### BACKGROUND

Such electrochemical sensors for measuring gases, also known as electrochemical gas sensors, are well known. These usually combine two or more electrical half-cells, comprising electrodes and electrolytes, which are separated from the surrounding environment by a housing. Electrolytes, such as sulphuric acid in aqueous solution, are generally penetrant liquids (creeping liquids/leakable liquids) that can escape through the smallest openings in the housing and enter the environment. The housing must therefore be suitably sealed to ensure that the electrolyte cannot escape.

Sealing the housing from the environment is particularly challenging at points where lead wires are routed through the housing to the outside. Lead wires are generally used to provide measurement signals from the electrodes.

A gas sensor with a circuit that electrically connects a potentiostat arranged outside the housing to the electrodes of the gas sensor is known from DE 10 2014 009 365 A1.

### SUMMARY

It is an object of the invention to provide a process for manufacturing an electrochemical gas sensor and an electrochemical gas sensor obtainable by the process, in which signal derivation is improved.

These and other problems are solved by a process for producing an electrochemical gas sensor according to the invention and by a corresponding electrochemical gas sensor according to the invention.

According to the invention, a process for producing an electrochemical gas sensor is provided in this respect. The process comprises the steps of: providing a substrate, the substrate having a through opening configuration, comprising one or more through openings (a number of through openings (1, or 2, or 3 . . . )) formed in the normal direction of the substrate, applying electrode material to an upper surface of the substrate and/or to a lower surface of the substrate, and bonding (joining) the electrode material and the substrate so that the through opening configuration is closed by the electrode material to obtain a contact surface configuration that comprises one or more contact surfaces (a number of contact surfaces) (contact pads) electrically contactable on the lower surface of the substrate opposite to the upper surface.

In this way, the contact surface configuration including one or more electrically contactable contact surfaces (a number of electrically contactable contact surfaces) can be obtained, which allow electrical contact with the housing interior without having to lead conductive wires into the housing.

By bonding the electrode material and substrate, an integral connection is achieved so that a substrate with electrode material formed therein or thereon is obtained. In this way, it is also possible to obtain a liquid-tight interface between the electrode material and substrate and thus a contact surface configuration including one or more (a number) of sealed electrically contactable contact surfaces by bonding the electrode material and substrate. Leakage and/or creep of electrolyte in the direction of the electrically contactable contact surfaces configuration can thus be prevented or at least reduced. An electrochemical gas sensor is an electrochemical cell that is configured to detect at least one gaseous substance (in particular a target gas) in a gas or in a gas mixture (in particular in a sample gas).

In the following, the terms “electrochemical gas sensor” and “gas sensor” are used interchangeably.

A substrate is a carrier material for electrode material.

For example, the substrate can be a porous material. For example, the substrate can be configured as a nonwoven made of glass fibers and/or glass particles. In another example, the substrate can be configured as a porous pellet made of materials such as ceramics, fibers, fabrics, plastics, glass powder and/or mixtures thereof. Particularly preferably, a porous pellet is obtained, i.e. provided, by pressing silica and/or glass dust with polytetrafluoroethylene powder and/or polypropylene powder.

The steps according to the invention “providing the substrate [ . . . ]”, “applying electrode material [ . . . ]” and “bonding electrode material [ . . . ]” can be carried out at different times or essentially simultaneously.

If the substrate is configured as a pellet, it is preferred that the electrode material is applied to material that is suitable for forming the substrate by pressing before the pellet is pressed and is bonded (i.e. pressed in) to the substrate during pressing. In this preferred embodiment, the steps of “providing a substrate [ . . . ]”, “applying electrode material [ . . . ]” and “bonding electrode material [ . . . ]” are performed substantially simultaneously.

The substrate can be configured as an essentially cylindrical disk.

The substrate can be treated to improve surface wettability.

The substrate can be configured as a membrane, for example, which can be suitable for absorbing an electrolyte, such as an aqueous electrolyte. The substrate is preferably hydrophilic for this purpose.

A normal direction of the substrate is understood to be a direction that is perpendicular to a bass surface (base level/base plane) of the substrate, i.e. a direction that corresponds to a normal vector of the base surface of the substrate.

A cross-sectional shape of the one or more through openings of the through opening configuration can be essentially arbitrary. In a simple example, a through opening (passage opening) can have a circular cross-section and extend through the substrate in an essentially cylindrical shape, for example. However, the cross-sectional shape of the one or more through openings of the through opening configuration can also be complex. For example, a through opening configuration may be formed by a network of pores in a porous substrate.

The electrode material can be applied in any way. However, it is preferred that the electrode material is applied by printing, i.e. by applying electrode material in liquid or paste form. For this purpose, the electrode material may be present as a component of a composition suitable for printing, in particular as a component of an ink. Essentially any printing process can be used. Suitable processes include, for example, screen printing, inkjet printing or matrix printing. It is preferred that the flow behavior of the ink, if present, is adapted to the geometry of the through opening configuration in such a way that the ink can penetrate into the one or more through openings of the through opening configuration. It is particularly preferred that the ink has a thixotropic flow behavior.

Electrode material is understood to be a material that is suitable for forming one or more electrically conductive elements in or on the substrate, either directly or through further steps.

In a preferred embodiment of the invention, the application of the electrode material and the bonding of the electrode material and substrate not only produces the electrode material that can be electrically contacted by means of the contact surfaces, but also forms an electrode of the gas sensor, such as a reference electrode, measuring electrode or counter electrode. However, this is not necessary. The process can also be used to obtain only the electrically contactable electrode material, which can be in direct or indirect contact with a separately provided electrode of the gas sensor.

In particular, in the event that an electrode of the gas sensor is obtained by applying the electrode material, it is preferred that the electrode material comprises a catalyst material, a film material, an adhesive material and/or a plastic.

The through opening configuration can comprise a single through opening or a plurality of through openings, in particular the number of through openings can be exactly one through opening or a plurality of through openings.

The number of through openings—the through opening configuration—can be introduced into the substrate by perforation, for example. Processes that are suitable for perforation include punching or lasering.

At least the step of applying electrode material to the top side of the substrate and/or to the bottom side of the substrate can be carried out several times. For example, separate segments of electrode material can be provided on or in the substrate, which can be contacted separately from one another by respective electrically contactable contact surfaces.

Preferably, the bonding (joining) of electrode material and substrate comprises a thermal treatment of substrate and electrode material.

The thermal treatment can be a sintering process, for example. The temperature of the thermal treatment should be adapted to the material properties of the substrate and electrode material. For example, the temperature of the thermal treatment can be in a range between 110° C. and 350° C.

Thermal treatment can achieve or improve the bond between the electrode material and the substrate.

Preferably, the substrate is configured as a gas-permeable and liquid-tight (liquid-impermeable) membrane. This is particularly preferred for electrodes that are to be in contact with an atmosphere (i.e. sample gas), for example for a measuring electrode or working electrode.

In this way, the composite of electrode material and substrate can be used to limit the gas sensor to the outside. The electrolyte can be arranged on one side of the composite or a volume can be provided to hold the electrolyte and the liquid-tight substrate can prevent the electrolyte from passing through the substrate. By making the substrate gas-permeable at the same time, this interface can allow sample gas to enter. By selecting the gas permeability, a possible gas volume flow into the gas sensor can be adjusted.

Alternatively, it is preferred that the substrate is configured as a liquid-wettable and preferably gas-tight separator.

In this alternative, the composite of electrode material and substrate within a volume of the gas sensor that is suitable for holding the electrolyte can be used to form an electrode that can be separated from another electrode by the substrate. This is particularly advantageous if the gas sensor is to be configured as a stacked structure.

Preferably, the substrate comprises a glass or a plastic.

Glass is understood to be a material comprising or consisting of silicon dioxide (SiO2), i.e. an inorganic, non-metallic glass.

In a variant of the invention, the glass can be made of silicon dioxide and is also referred to as quartz glass in this case.

In a further variant of the invention, the glass may comprise other components in addition to silicon dioxide, in particular oxides such as aluminum oxide, alkali oxide, phosphorus pentoxide and/or boron trioxide. The glass may further additionally or alternatively comprise halide ions.

A silicate is understood to be a salt and/or an ester of an orthosilicic acid (Si(OH)4) and its condensates.

Preferably, the electrode material comprises the glass and/or a metal and/or a metal oxide and/or the plastic and/or carbon.

Preferably, the metal and/or the metal oxide is selected from the group comprising: platinum, platinum oxide, gold, gold oxide, iridium, iridium oxide, silver, silver oxide, ruthenium, ruthenium oxide, rhodium, rhodium oxide, palladium, palladium oxide, copper, copper oxide and nickel.

Preferably, the plastic is selected from the group comprising: polytetrafluoroethylene (PTFE), polyethylene (PE), polyethylene terephthalate (PET), polypropylene (PP), polyvinyl chloride (PVC), polyether ether ketone (PEEK), perfluoroalkoxy polymer (PFA), polyvinylidene fluoride (PVDF), polyamide (PA), polyurethane (PU), and tetrafluoroethylene-hexafluoropropylene copolymer (FEP or TFE/HFP).

The aforementioned materials have proven to be particularly suitable for the formation of substrates and/or contact surfaces and/or electrodes.

Preferably, the process further comprises the step of: providing an electrode on the substrate, wherein the electrode is obtained by applying the electrode material to the top surface of the substrate and/or to the bottom surface of the substrate, or wherein the electrode is obtained by an additional application of additional electrode material to the electrode material and/or to the top surface of the substrate and/or to the bottom surface of the substrate.

In this way, an electrode can either be obtained directly by applying the electrode material and be integrally connected to the substrate (as a one piece structure) or be obtained by an additional step.

The composition of the additional electrode material can be different from or similar to that of the electrode material. A different composition is particularly preferred if the material properties of the electrode material and the material properties of the electrode are to be different.

Preferably, the process further comprises the step of: hydrophilizing a surface of the electrode.

In this way, the wettability of the resulting electrode with aqueous electrolyte can be improved.

One example of hydrophilization is to coat the electrode material with a less hydrophobic layer.

According to the invention, there is further provided an electrochemical gas sensor which is obtainable by a process as described above.

Preferably, in addition to the substrate with the electrode material or with the electrode, the gas sensor also has: a sensor housing, optionally a diffusion barrier which impedes the passage of gas from an exposure to the substrate, optionally a sealing element which is arranged between the substrate and the sensor housing, and an electrical lead configuration, including one or more electrical leads (a number of electrical leads) (electrical conductors) which are electrically connected to the electrically contactable contact surface configuration (the number of electrically contactable contact surfaces).

These and other features, advantages and preferred embodiments of the invention are also apparent from the following description of the figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a sectional view of an embodiment of a gas sensor according to the invention;

FIG. 2 is a sectional view of a further embodiment of a gas sensor according to the invention;

FIG. 3 is a sectional view of an embodiment of a substrate according to the invention;

FIG. 4 is a flow diagram of an embodiment of a process according to the invention.

### DESCRIPTION OF PREFERRED EMBODIMENTS

Referring to the drawings, according to the invention, a process 100 for manufacturing an electrochemical gas sensor 200 is provided. An embodiment example of such a process 100 comprising steps S1, S2, . . . is shown in FIG. 4.

Step S1 is to provide a substrate 40, the substrate 40 having a through opening configuration comprising through openings 41a, 41b formed in the substrate 40 in the normal direction.

An example of a substrate 40 having a through opening configuration comprising through

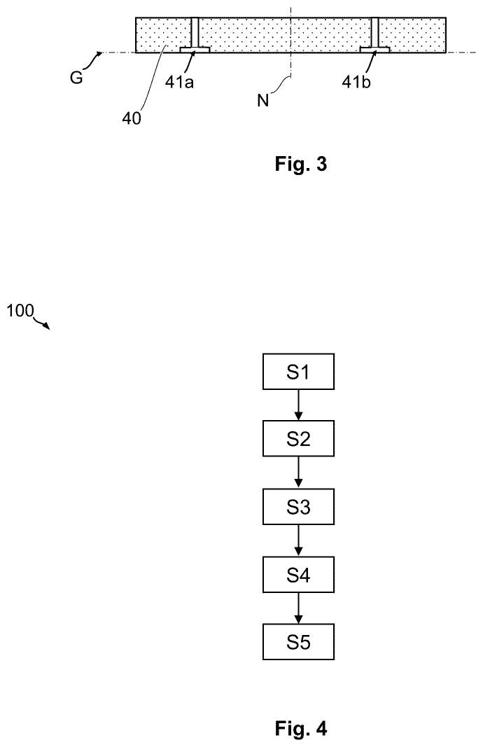

openings 41a, 41b formed in the normal direction N of the substrate 40 is shown in FIG. 3. The substrate can have a base surface G to which the normal direction N extends perpendicularly. In the possible case that the base surface G is not flat, the normal direction N is formed by a perpendicular on a tangential plane at the base surface G.

In the example shown, the substrate 40 includes a through opening configuration that has two through openings 41a and 41b, which have a non-constant cross-section when viewed in the normal direction N. Thus, a part of the respective through opening 41a, 41b located at the top in the viewing plane is essentially cylindrical in shape, while a part of the respective through opening 41a, 41b located at the bottom in the viewing plane has a widened cross-sectional area compared to the part located at the top. However, this is not necessary.

The substrate 40 of all embodiments can be configured, for example, as a gas-permeable and liquid-tight membrane or as a liquid-wettable separator.

The substrate 40 may comprise, for example, a glass or a plastic. The plastic may be selected from the group comprising: PTFE, PE, PET, PP, PVC, PEEK, PFA, PVDF, PA, PU and FEP.

The process 100 according to FIG. 4 further comprises step S2: Applying electrode material 50a, 50b, 50c to an upper surface O of the substrate 40 and/or to a lower surface U of the substrate 40.

The process 100 according to FIG. 4 further comprises step S3: Bonding (joining)

electrode material 50a, 50b, 50c and substrate 40 so that the through openings 41a, 41b are closed by the electrode material 50a, 50b, 50c to obtain an electrically contactable contact surface configuration comprising a number of contact surfaces 51a, 51b electrically contactable on the bottom surface U of the substrate 40 opposite to the top surface O.

The process 100 may further comprise step S4: Providing an electrode 30 on the substrate 40, wherein the electrode 30 is obtained by applying the electrode material 50a, 50b, 50c to the top surface O of the substrate 40 and/or to the bottom surface U of the substrate 40, or wherein the electrode 30 is obtained by additionally applying additional electrode material 52 to the electrode material 50b and/or to the top surface O of the substrate 40.

A gas sensor 200, which is obtainable by the process 100, is shown in FIG. 1.

In this respect, the gas sensor 200 has a substrate 40, for example the substrate 40 according to FIG. 3, in which the through opening configuration, comprising through openings 41a, 41b, is closed by the electrode material 50a, 50b, 50c applied to the upper side O and/or to the lower side U of the substrate 40, in order to obtain an electrically contactable contact surface configuration comprising the number of electrically contactable contact surfaces 51a, 51b on the lower side U in this example.

In the exemplary gas sensor 200 shown in FIG. 1, the electrode material 50b, which has been applied to the upper side O, forms a layer on the substrate 40. However, this is not necessary; all that is required is that the electrode material 50a, 50c closes the through openings 41a, 41b and forms the electrically contactable contact surfaces 51a, 51b described above.

It is advantageous, and shown in FIG. 1, that the electrode material 50b forms an electrode 30 of the gas sensor 200. In this way, an electrical contact between the electrode material 50a, 50c and the electrode 30 can be provided particularly easily.

The electrically contactable contact surfaces 51a, 51b can, for example, be electrically

contacted by electrical leads 60a, 60b. The exact configuration of the electrical leads 60a, 60b can be essentially arbitrary. For example, the electrical leads 60a, 60b can be metal elements.

The substrate 40 can be accommodated in the gas sensor 200 by the housing of the gas sensor 200. In the example shown in FIG. 1, this is realized by the housing being configured in two parts with a first housing part 10a and a second housing part 10b. The substrate 40 can then be accommodated between the first housing part 10a and the second housing part 10b. It is possible and shown that the gas sensor 200 can furthermore have a sealing element 20, such as an O-ring 20, in order to be able to receive the substrate 40 sealed in or on the housing.

The gas sensor 200 can have any number of other elements, such as other electrodes not shown, for example reference electrodes, counter electrodes and measuring electrodes.

As shown in FIG. 1, the gas sensor 200 can have a diffusion barrier 70. This can form a gas inlet or a gas outlet of the gas sensor 200. In an example not shown, the gas sensor 200 can also have a further diffusion barrier, which can be arranged below the substrate 40 in relation to the viewing plane.

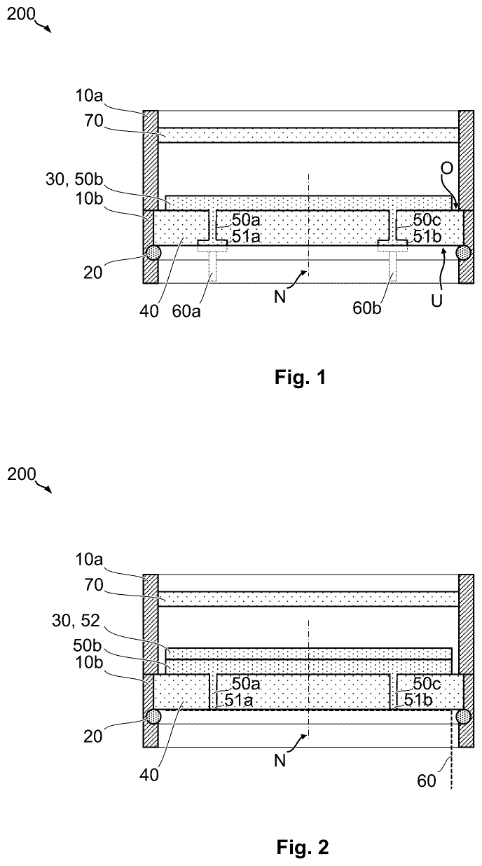

FIG. 2 shows a further example of a gas sensor 200. Since the gas sensor 200 according to FIG. 2 is similar to that according to FIG. 1, only the differences to the gas sensor 200 according to FIG. 1 are described.

In contrast to the gas sensor 200 according to FIG. 1, an electrode 30 of the gas sensor 200 according to FIG. 2 is not formed directly by the applied electrode material 50b, but by an additional layer which is applied to the electrode material 50b. This additional layer is formed by additional electrode material 52. The additional layer can be obtained, for example, by an additional printing step or by any other process. It is advantageous if the electrode 30 is in direct contact with the electrode material 50b, so that the electrode 30 can be electrically contacted by means of the electrically contactable contact surface configuration that comprises the number of electrically contactable contact surfaces 51a, 51b.

In the embodiment example according to FIG. 2, the electrical lead 60 is in the form of a metal wire which contacts both the contact surface 51a and the contact surface 51b. However, any other form of electrical lead 60 is possible.

In any of the embodiments according to FIG. 1 and FIG. 2, a volume within the gas sensor 200 may be at least partially filled with an electrolyte.

In all embodiments described, it is possible that the electrode material 50a, 50b, 50c and the substrate 40 are bonded by a thermal treatment of the substrate 40 and the electrode material 50a, 50b, 50c. An example of such a thermal treatment is sintering.

In all described embodiments, it is possible that the electrode material 50a, 50b, 50c comprises a glass and a metal and/or a metal oxide and/or the plastic and/or carbon. The same applies to the additional electrode material 52, if present.

Preferably, the metal and/or metal oxide is selected from the group comprising: platinum, platinum oxide, gold, gold oxide, iridium, iridium oxide, silver, silver oxide, ruthenium, ruthenium oxide, rhodium, rhodium oxide, palladium, palladium oxide, copper, copper oxide and nickel.

Preferably, the plastic is selected from the group comprising: PTFE, PE, PET, PP, PVC, PEEK, PFA, PVDF, PA, PU and FEP.

It is possible in all described embodiments that the process further comprises step S5: Hydrophilizing a surface of the electrode 30.

All of the features described herein can be combined with each other as desired, provided that this does not affect alternatives or is contradictory.

While specific embodiments of the invention have been shown and described in detail to illustrate the application of the principles of the invention, it will be understood that the invention may be embodied otherwise without departing from such principles.

### LIST OF REFERENCE CHARACTERS

10a First housing part
10b Second housing part
20 Sealing element, O-ring
30 Electrode
40 Substrate
41a Through opening
41b Through opening
50a, 50b, 50c Electrode material
51a, 51b Contact area
52 Additional electrode material
60, 60a, 60 Electrical leads (electrical conductors)
70 Diffusion barrier
100 Process
200 Gas sensor, electrochemical gas sensor
G Base area
N Normal direction
O Top side
S1, S2 . . . Process steps
U Bottom side

What is claimed is:

1. A process for producing an electrochemical gas sensor, the process comprising the steps of:
providing a substrate having a through opening configuration, wherein the through opening configuration comprises one or more through openings formed in a normal direction of the substrate;
applying electrode material to an upper surface of the substrate and/or applying electrode material to a lower surface of the substrate; and
bonding the electrode material and the substrate so that the through opening configuration is closed by the electrode material to obtain a contact surface configuration electrically contactable on the lower surface of the substrate opposite to the upper surface, wherein the contact surface configuration comprises one or more contact surfaces.

2. A process according to claim 1, wherein the bonding of the electrode material and the substrate comprises a thermal treatment of the substrate and the electrode material.

3. A process according to claim 1,
wherein the substrate is configured as a gas-permeable and liquid-tight membrane, or
wherein the substrate is configured as a liquid-wettable separator.

4. A process according to claim 2,
wherein the substrate is configured as a gas-permeable and liquid-tight membrane, or
wherein the substrate is configured as a liquid-wettable separator.

5. A process according to claim 1,
wherein the substrate comprises a glass or a plastic,
wherein the electrode material comprises the glass and/or a metal and/or a metal oxide and/or the plastic and/or carbon.

6. A process according to claim 5, wherein the metal and/or the metal oxide is selected from the group comprising: platinum, platinum oxide, gold, gold oxide, iridium, iridium oxide, silver, silver oxide, ruthenium, ruthenium oxide, rhodium, rhodium oxide, palladium, palladium oxide, copper, copper oxide and nickel.

7. A process according to claim 5, wherein the plastic is selected from the group comprising: PTFE, PE, PET, PP, PVC, PEEK, PFA, PVDF, PA, PU and FEP.

8. A process according to claim 6, wherein the plastic is selected from the group comprising: PTFE, PE, PET, PP, PVC, PEEK, PFA, PVDF, PA, PU and FEP.

9. A process according to claim 1, further comprising the step of providing an electrode on the substrate, wherein:
the electrode is obtained by the step of applying the electrode material to the upper surface of the substrate and/or applying the electrode material to the lower surface of the substrate, or
the electrode is obtained by an application of additional electrode material to the electrode material applied to the upper side of the substrate and/or applied to the lower side of the substrate.

10. A process according to claim 9, further comprising the step of hydrophilization a surface of the electrode.

11. An electrochemical gas sensor formed by a process comprising the steps of:
providing a substrate having a through opening configuration, wherein the through opening configuration comprises one or more through openings formed in a normal direction of the substrate;
applying electrode material to an upper surface of the substrate and/or applying electrode material to a lower surface of the substrate; and
bonding the electrode material and the substrate so that the through opening configuration is closed by the electrode material to obtain a contact surface configuration electrically contactable on the lower surface of the substrate opposite to the upper surface, wherein the contact surface configuration comprises one or more contact surfaces.

12. An electrochemical gas sensor according to claim 11, further comprising:
a sensor housing, wherein the substrate is connected to the sensor housing; and
an electrical lead configuration, wherein the electrical lead configuration comprises one or more electrical leads, wherein the electrical lead configuration is connected to the contact surface configuration.

13. An electrochemical gas sensor according to claim 12, further comprising:
a diffusion barrier connected to the sensor housing and configured to hinder a passage of gas from an environment to the substrate and/or to an interior of the sensor housing; and
a sealing element arranged between the substrate and the sensor housing.

14. An electrochemical gas sensor according to claim 12, wherein the bonding of the electrode material and the substrate comprises a thermal treatment of the substrate and the electrode material.

15. An electrochemical gas sensor according to claim 12,
wherein the substrate is configured as a gas-permeable and liquid-tight membrane, or
wherein the substrate is configured as a liquid-wettable separator.

16. An electrochemical gas sensor according to claim 12,
wherein the substrate comprises a glass or a plastic,
wherein the electrode material comprises the glass and/or a metal and/or a metal oxide and/or the plastic and/or carbon.

17. An electrochemical gas sensor according to claim 16, wherein the metal and/or the metal oxide is selected from the group comprising: platinum, platinum oxide, gold, gold oxide, iridium, iridium oxide, silver, silver oxide, ruthenium, ruthenium oxide, rhodium, rhodium oxide, palladium, palladium oxide, copper, copper oxide and nickel.

18. An electrochemical gas sensor according to claim 16, wherein the plastic is selected from the group comprising: PTFE, PE, PET, PP, PVC, PEEK, PFA, PVDF, PA, PU and FEP.

19. An electrochemical gas sensor according to claim 12, further comprising an electrode on the substrate, wherein:
the electrode comprises the electrode material at the upper surface of the substrate and/or the electrode material at the lower surface of the substrate, or
the electrode comprises additional electrode material applied to the electrode material at the upper side of the substrate and/or at the lower side of the substrate.

20. An electrochemical gas sensor according to claim 19, the electrode comprises a surface that has been hydrophilized.
